(19) United States
(12) Patent Application Publication
(10) Pub. No.: US 2007/0150352 A1
(43) Pub. Date: Jun. 28, 2007

(54) Techniques for transaction data coordination

(75) Inventors: Carole Kelly-Frank, Wildwood, MO (US); Sara Fiebiger, Ellisville, MO (US); Anant Nambiar, Larchmont, NY (US); Julie Wang, Brooklyn, NY (US)

Correspondence Address: Ryan, Mason & Lewis, LLP, Suite 205, 1300 Post Road, Fairfield, CT, 06824, US

(73) Assignee: MasterCard International Incorporated, Purchase, NY (US)

(21) Appl. No.: 11/642,340

(22) Filed: Dec. 20, 2006

Related U.S. Application Data
(60) Provisional application No. 60/753,963, filed on Dec. 23, 2005.

(51) Int. Cl. G06Q 30/00

(52) U.S. Cl. 705/14

(57) ABSTRACT

A method for coordinating transaction data for targeted offer generation includes facilitating opt-in to a cardholder offer generation scheme, and facilitating obtaining transaction data associated with a card transaction, via a payment card processing network. The transaction data includes (i) attribute data indicative of an attribute of at least one item purchased, and (ii) an account number of the card. Storage of at least the attribute data in a data warehouse is facilitated, in association with indicia of the holder. The steps can be repeated for a plurality of transactions at a plurality of sales entities, to generate a cross-transaction, cross-entity, actual-product-purchased-based data warehouse profile of the holder. Generating a non-real-time offer to the holder by an operator of the payment card network is facilitated, based, at least in part, on data mining performed on the data warehouse profile.

### CROSS-REFERENCE TO RELATED APPLICATIONS

This patent application claims the benefit of U.S. Provisional Patent Application Ser. No. 60/753,963 filed on Dec. 23, 2005, and entitled “Techniques for Transaction Data Coordination.” The disclosure of the aforementioned Provisional Patent Application Ser. No. 60/753,963 is expressly incorporated herein by reference in its entirety.

### FIELD OF THE INVENTION

The present invention relates generally to electronic commerce, and, more particularly, to electronic payment systems.

### BACKGROUND OF THE INVENTION

Manufacturers and merchants continually seek new techniques for marketing and product promotion. Such activities may be enhanced where there is knowledge of the consuming preferences of a targeted individual. U.S. Pat. No. 6,885,994 to Scroggie et al. discloses a system and method for providing shopping aids and incentives to customers through a computer network, such as by E-mail over the Internet or the World Wide Web. Customers of retail stores can establish a bi-directional communication link with the system, log in to the system, and then elect to browse among available purchasing incentive offers, or elect to explore other shopping aids, such as a shopping list generator, a recipe center, or simply elect to claim a product rebate or to receive product information.

If the customer elects to have product information or rebate information delivered, only minimal customer identification is required. For purchase incentives redeemable at retail stores, the customer must provide identification information and must also designate a retailer at which the purchasing incentive can be exercised. For receipt of focused incentives based on the customer's past shopping behavior, the customer must also supply a unique customer ID, such as a check cashing card number or credit card number, used for in-store purchases. For delivery of a product sample, the customer's name and address must be supplied. The system merges this customer-supplied information with other purchase incentive data and creates a printable graphical image of the purchasing incentive for transmission to the customer.

In an alternate approach, the purchase incentive is not transmitted directly to the customer. Instead, the terms of the incentive are transmitted electronically to the retail store designated by the customer, who receives either a token to present at the store or an advisory message. In another alternate approach, incentives may be targeted to specific consumers based on a consumer purchase history, and transmitted to consumers' computers using electronic mail addresses stored in a consumer database.

US Patent Application Publication No. 2004/0024638 of Restis is entitled “Computerized credit information system coupon coding.” It appears to disclose a device allowing the use of the credit card information system to convey details of the products sold and further to re-convey coupon information to the retailer. The primary server functions as an arbiter or communicator between the retailer's computer system/POS terminal and those large computers used to verify transaction information, i.e. receiving and retransmitting packets of data between other computers which handle processing of the information. Database maintenance and access, transaction processing, coupon UPC matching and transmission and other tasks are carried out by the coupon server. The additional information which needs to be sent and retransmitted is the product identifier (for example, a UPC code). Since UPC codes are also used for coupon information, this functions in both directions. Price adjustment based upon coupons is still carried out normally at the register. The software necessary to carry out the operation at the POS station/register level may be implemented in parallel to the retailer's normal transaction applications.

U.S. Pat. No. 6,925,441 of Jones III et al. is entitled “System and method of targeted marketing.” It appears to disclose a system and method of targeted marketing to consumers, including businesses and associates, based upon the financial characteristics of the consumer, type of offer being made and the channel of communication for delivery of the offer. The consumer is characterized based upon financial, behavioral, and socioeconomic factors. The offer is characterized based upon the consumer and the potential for the consumer accepting the offer. The channel of communication for delivery of the offer is also characterized and combined with the consumer and consumer-offer characteristics to arrive at a net present value of the offer to be made. If the net present value is sufficient the offer is processed and presented to the consumer. If the net present value is not sufficient, the offer is revised to present a better value to the consumer (or discarded if the required offer value can not be created) thereby enhancing the chances that the consumer will accept the offer in question.

U.S. Pat. No. 6,055,513 of Katz is entitled “Methods and apparatus for intelligent selection of goods and services in telephonic and electronic commerce.” It appears to disclose apparatus and methods for effecting remote commerce, such as in telemarketing (either inbound or outbound) and in electronic commerce, which are particularly adapted for the intelligent selection and proffer of products, services or information to a user or customer. Goods, service or information are provided to the user via electronic communication, such as through a telephone, videophone or other computer link, as determined by the steps of first, establishing communication via the electronic communications device between the user and the system to effect a primary transaction or primary interaction, second, obtaining data with respect to the primary transaction or primary interaction, including at least in part a determination of the identity of the user or prospective customer, third, obtaining at least a second data element relating to the user, fourth, utilizing the primary transaction or primary interaction data along with the at least second data element as factors in determining at least one good, service or item of information for prospective upsell to the user or prospective customer, and offering the item to the prospective customer. In the preferred embodiment, the selection of the proffer of goods, services or information comprises an upsell with respect to the primary transaction or primary interaction data. The offer of the upsell is preferably generated and offered in real time, that is, during the course of the communication initiated with the primary transaction or primary interaction.

U.S. Pat. No. 5,857,175 to Day et al. is entitled “System and method for offering targeted discounts to customers.” It appears to disclose a system for presenting customized special offers to customers, the special offers including targeted offers to a customer selected from a plurality of customers, and for collecting purchasing behavior information concerning the customers, the system comprising a computer including a database containing customer account information providing information specific to a particular customer account; the computer also including a database containing special offers including a targeted offer which is to be made to selected customer accounts on the basis of targeted offer targeting parameters; a plurality of customer cards, each customer card having machine readable card information indicating at least identification of the card with a particular customer account; a customer interface in communication with the computer to transfer data therebetween; the customer interface having a card reader for reading machine readable card information from the customer card; the computer including means for generating a customized customer offer list available to that particular customer account which includes the special offer; an offer communicator for communicating the customer offer list to the customer for which it is generated; a check-out at which the customer presents purchased item information indicating items being purchased by the customer; the check-out including a card reader for reading the customer card; the computer including means for sending information from the customized customer offer list to the check-out; the computer further including means for collecting customer purchase information which is indicative of items being purchased by the customer via the check-out; the computer still further including means for editing the customer account information to reflect items purchased by the customer.

U.S. Pat. No. 5,687,322 of Deaton is entitled “Method and system for selective incentive point-of-sale marketing in response to customer shopping histories.” U.S. Pat. No. 6,684,195 of Deaton is entitled “Method and system for selective incentive point-of-sale marketing in response to customer shopping histories.” The Deaton references appear to disclose a system and method for customer promotion. A terminal enters a customer's identification code, along with customer transaction data, at the point-of-sale. A memory stores a database of previously entered customer identification codes and transactions data. Circuitry is provided for generating a signal representative of a customer's shopping history, wherein incentive coupons may be issued to customers in dependence upon the signal.

A need exists for a substantial improvement of current techniques.

### SUMMARY OF THE INVENTION

Principles of the present invention provide techniques for transaction data coordination. An exemplary embodiment of a method (which can be computer-implemented), according to one aspect of the invention, for coordinating transaction data for targeted offer generation, includes steps set forth below. The transaction data is associated with a payment card (broadly understood to include non-traditional items that perform payment card functions, e.g., cell phone, personal digital assistant (PDA), and the like) of a holder, and the payment card is usable in a payment card processing network. In one step, opt-in to a cardholder offer generation scheme is facilitated. In another step, obtaining transaction data associated with a transaction conducted with the card is facilitated. The transaction data is obtained via the payment card processing network. The transaction data includes (i) attribute data indicative of an attribute of at least one item purchased in the transaction (for example, universal product code (UPC) or stock keeping units (SKUs)), and (ii) an account number of the card, the account number identifying the holder.

In another step, storage of at least the attribute data in a data warehouse is facilitated. The storage is in association with indicia of the holder (for example, account number), in a form for subsequent data mining thereon. The steps of (i) facilitating obtaining the transaction data, and (ii) facilitating storage, can be repeated for a plurality of transactions at a plurality of sales entities, to generate a cross-transaction, cross-entity, actual-product-purchased-based data warehouse profile of the holder. In another step, generating a non-real-time offer to the holder is facilitated. The offer can be based, at least in part, on data mining performed on the data warehouse profile, the offer being generated by an operator of the payment card network (optionally based on input from a third party).

An exemplary embodiment of an apparatus for coordinating transaction data for targeted offer generation includes a memory and at least one processor coupled to the memory and operative to perform one or more of the method steps described herein. In another aspect, an apparatus for coordinating transaction data for targeted offer generation includes means for performing one or more method steps as described herein. The means can include hardware modules, software modules, or combinations thereof. Further, one or more method steps of the present invention can be implemented in the form of an article of manufacture comprising a machine readable medium that contains one or more programs which when executed implement described method step(s).

Techniques of the present invention can provide substantial beneficial technical effects. These can include, for example, enhancement to computational and communications efficiency by passing transaction data needed for marketing through the payment system infrastructure, with offer generation by the payment system (payment card network) operator.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an example of a system that can implement techniques of the present invention;

FIG. 2 shows one specific exemplary application of techniques of the present invention at a check-out;

FIG. 3 is a flow chart of an exemplary method according to an aspect of the present invention;

FIG. 4 shows an exemplary design flow for one specific detailed implementation of techniques according to the present invention; and

FIG. 5 is a block diagram of an exemplary computer system useful in one or more embodiments of the present invention.

### DETAILED DESCRIPTION OF PREFERRED EMBODIMENTS

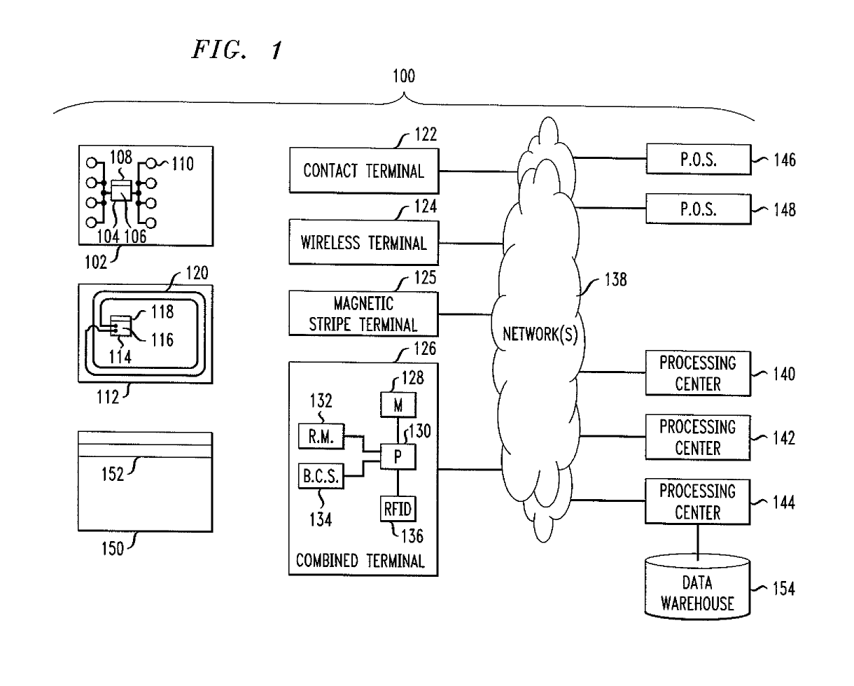

Attention should now be given to FIG. 1, which depicts an exemplary embodiment of a system 100, according to an aspect of the present invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed with techniques of the present invention. Other types of devices could include a conventional card 150 having a magnetic stripe 152, an appropriately configured cellular telephone handset, PDA, and the like.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) or personal identification number (“PIN”). The memory portions or units 108, 118 can store the operating system of the cards 102, 112. The operating system loads and executes applications and provides file management or other basic card services to the applications. In some embodiments, one or more applications may “sit” directly on hardware, e.g., may be outside the domain of the operating system. One operating system that can be used to implement the present invention is the MULTOS® operating system licensed by StepNexus Inc. Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one preferred standard to which such applications may conform is the EMV payment standard set forth by EMVCo, LLC (http://www.emvco.com). It will be appreciated that, strictly speaking, the EMV standard defines the behavior of a terminal; however, the card can be configured to conform to such EMV-compliant terminal behavior and in such a sense is itself EMV-compliant. It will also be appreciated that applications in accordance with the present invention can be configured in a variety of different ways.

As noted, cards 102, 112 are examples of a variety of payment devices that can be employed with techniques of the present invention. The primary function of the payment devices may not be payment, for example, they may be cellular phone handsets that implement techniques of the present invention. Such devices could include cards having a conventional form factor, smaller or larger cards, cards of different shape, key fobs, personal digital assistants (PDAs), appropriately configured cell phone handsets, or indeed any device with the capabilities to implement techniques of the present invention. The cards, or other payment devices, can include memories 108, 118 and processors 106, 116 coupled to the memories. Optionally, body portions (e.g., laminated plastic layers of a payment card, case or cabinet of a PDA, chip packaging, and the like) are associated with memories 108, 118 and processors 106, 116. The memories 108, 118 can contain applications to facilitate one or more method steps as described herein. The processors 106, 116 can be operative to facilitate execution one or more method steps to be described herein, for example, by running the application(s). The applications can be, for example, application identifiers (AIDs) linked to software code in the form of firmware plus data in a card memory such as an electrically erasable programmable read-only memory (EEPROM). Again, note that “smart” cards are not necessarily required and a conventional magnetic stripe card can be employed. In such case, processing to effectuate method steps described herein can be conducted, for example, at the terminal(s), processing center(s), and/or data warehouse(s).

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network. More than one network could be employed to connect different elements of the system. Processing centers 140, 142, 144 can include, for example, a host computer of an issuer of a payment device.

Many different retail or other establishments, represented by points-of-sale 146, 148, can be connected to network 138. Each such establishment can have one or more terminals. Further, different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” cards 102, 112, or the handset chassis and body in the case of a cellular telephone.

It will be appreciated that the terminals 122, 124, 125, 126 are examples of terminal apparatuses for coordinating transaction data associated with a payment device of a holder in accordance with one or more exemplary embodiments of the present invention. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can be provided, and can be coupled to the processor, to gather attribute data, such as a product identification, from a UPC code or RFID tag on a product to be purchased.

The above-described devices 102, 112 can be ISO 7816-compliant contact cards or devices or ISO 14443-compliant proximity cards or devices. In operation, card 112 can be touched or tapped on the terminal 124 or 128, which then contactlessly transmits the electronic data to the proximity IC chip in the card 112 or other wireless device.

One or more of the processing centers 140, 142, 144 can include a database such as a data warehouse 154.

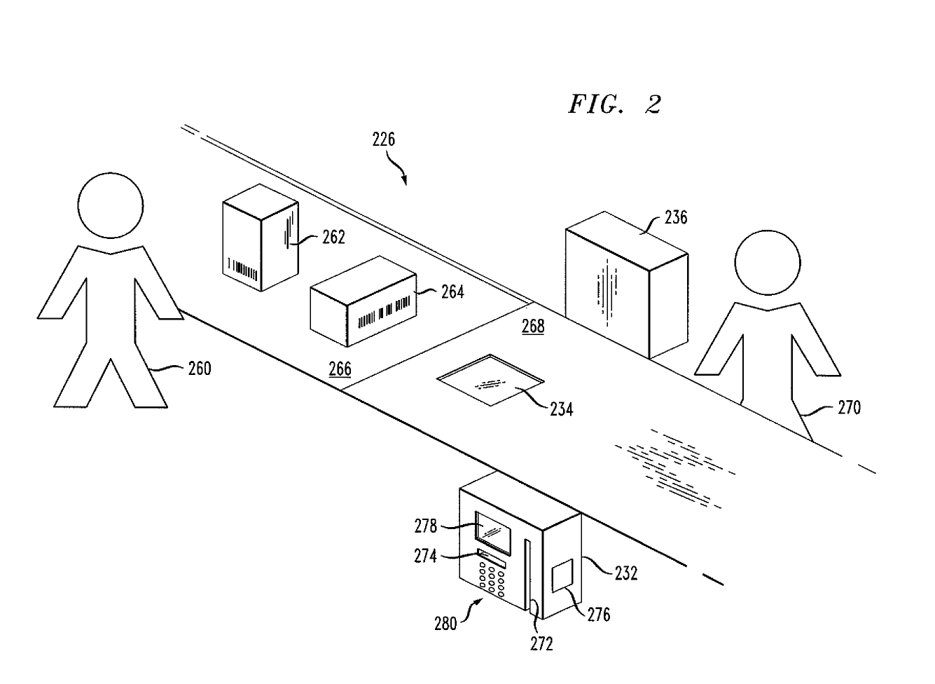

Attention should now be given to FIG. 2, which depicts a combined terminal 226 employing certain techniques of the present invention applied to an exemplary retail check-out. It is to be understood that this is illustrative of one of many possible applications of techniques of the present invention. Elements in FIG. 2 similar to those in FIG. 1 have received the same reference character incremented by 100 and will not be described in detail again. Thus, reader module 232, bar code reader 234, and RFID tag reader 236, are similar to those discussed above with respect to FIG. 1.

When a holder 260 of a card or other payment device wishes to make a purchase of one or more items 262, 264, he or she places the items on a conveyor 266 which conveys them to a region 268 adjacent a check-out person 270 who can cause the scanner 234 to read the UPC bar codes and/or the RFID tag reader 236 to read the RFID tags, if equipped. The items 262, 264 in the example of FIG. 2 have UPC bar codes. Holder 260 causes a payment card or other payment device to communicate with module 232 (for example by touching or tapping at a designated location 276, or holding in close proximity to such location; or by sliding a magnetic stripe through slot 272, or by inserting a card into region 274, for example, for contact reading). A keypad 280 and display 278 can be provided on module 232. During the process depicted, a processor (not shown) coupled to the appropriate elements in the terminal 226 can effect the various method steps described herein, either alone, or in conjunction with a remote processor in a processing center, and/or on a “smart” payment device. Alternatively, such other processor or processors could control performance of one or more method steps. Again, it should be emphasized that one or more method steps depicted herein could be carried out under terminal control, control via a processor at a remote processing center, or even with the aid of processing capability of a “smart” card, or via a combination of any two or more of the foregoing. Further, SKUs or other data could be gathered in lieu of or in addition to UPCs.

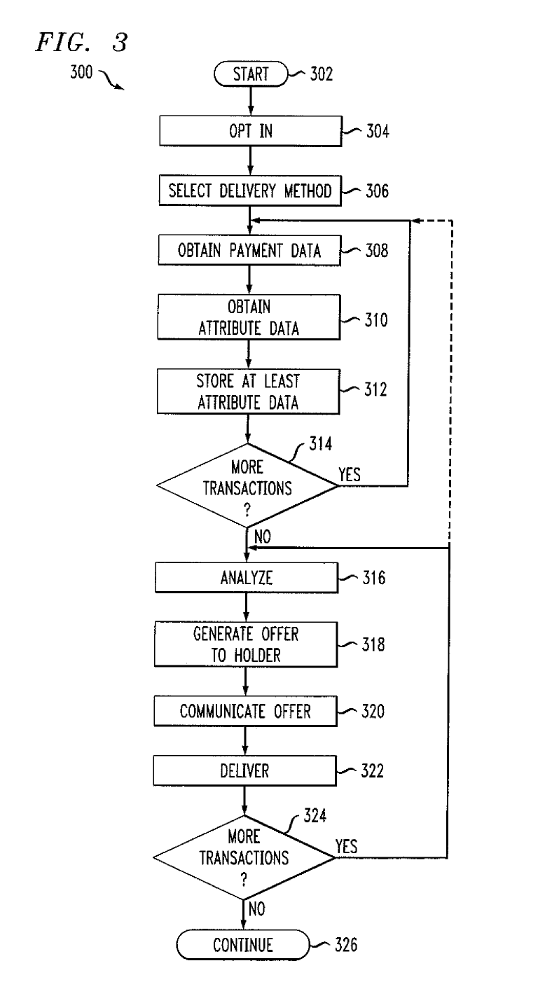

Attention should now be given to FIG. 3, which shows a flow chart 300 of exemplary method steps in a method, which can be computer-implemented, for coordinating transaction data for targeted offer generation. The transaction data is associated with a payment card (broadly understood, as used herein, including the claims, to include non-traditional items that perform payment card functions, e.g., cell phone, PDA, and the like) of a holder. The payment card is usable in a payment card processing network such as 100. It is to be emphasized that sequences and steps other than those shown in FIG. 3 are also within the scope of the present invention. After beginning at block 302, the method includes a step 304 of facilitating opt-in to a cardholder offer generation scheme. The opt-in can be by the holder, by the issuer on behalf of the holder, and so on. Opt-in refers to a process whereby the user (or party acting for the user) is made aware of a program implementing one or more techniques of the present invention, and voluntarily chooses to participate therein. As used herein, including the claims, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. Optional step 306 includes facilitating selection of an offer delivery method (e.g., as a stored value bonus card, statement credit, and the like) by or on behalf of the holder

Steps 308 and 310 are exemplary of a step of facilitating obtaining transaction data associated with a transaction conducted with the card. The transaction data is obtained via the payment card processing network. The transaction data includes attribute data, as per block 310, indicative of an attribute of at least one item (product and/or service) purchased in the transaction (e.g., UPC or SKU number(s) or other data). Of course, transactions may involve purchase of multiple items, and data reflective of multiple items can be obtained. The transaction data also includes an account number of the card, the account number identifying the holder. This is indicated by “Obtain payment data” block 308. In addition to the account number, the payment data can optionally include, for example, ordinary data listing the amount of a transaction gathered in the course of conventional credit or debit card transactions.

The attribute data in block 310 can optionally be obtained substantially simultaneously with the payment data (i.e., at the same time, just before, or just after, and the obtaining can be performed in multiple sub-steps at any of the indicated times, such as both before and after). In one or more embodiments of the invention, step 310 can be conducted automatically in association with step 308. Thus, gathering customer data can be transparent to a holder of a card or other payment device, by simply reading the account number or other data available on the payment device, without any need for the customer to enter identifying data. (Security could of course be provided via the customer entering his or her personal identification number (PIN).) Additional useful customer data might be present on a “smart” card, or might be stored in a remote database and retrieved based on the account number or other identifying indicia. In one or more embodiments, the attribute data can be obtained during a clearing operation, for example, as a record in a file associated with the clearing operation. By way of example, within the MASTERCARD® transaction processing context, the record could be a generic addendum record or a specific corporate addendum record. Thus, the data would be present at the terminal or at another computer of a merchant, and then transmitted during the clearing process.

In one or more embodiments, the attribute data comprises numerical indicia (UCCs, SKUs), and the method can include the additional step of translating the numerical indicia into offer intelligence data via a data table associated with the data warehouse. This optional step is not explicitly shown, but could be performed, for example, when the data is stored in step 312 or analyzed in step 316.

Step 312 includes facilitating storage of at least the attribute data in a data warehouse (such as 154), in association with indicia of the holder (such as the account number), in a form for subsequent data mining thereon. The attribute data can be, for example, the Universal Product Code (UPC) bar code associated with a purchased item, or could be similar identifying data available from an RFID tag, SKU data, and the like.

Additional data can optionally be stored in step 312, for example, one or more of quantity data associated with the transaction, supplemental item description data, and a price associated with the item. This could be accomplished, for example, by the aforementioned record in a file associated with the clearing operation. In another possible approach, the attribute data comprises a promotion code tied to the at least one item. This could be done during clearing or during the authorization process, when the requested transaction to be conducted with the card is authorized.

As just noted, facilitating storage of the attribute data can include communicating the attribute data to the data warehouse via a clearing and settlement system. Such systems are per se well known to persons skilled in payment industry aspects of the electronic commerce art. As noted, in one or more preferred embodiments of the invention, the attribute data can be UPC codes or SKUs. Step 316 (or 312) could encompass an additional step of translating the UPC codes into offer intelligence data via a data table associated with (e.g., resident in) the data warehouse. The functionality described in this paragraph could utilize the addendum record. Under this scenario, multiple UPC codes from a single transaction event would be communicated through the clearing and settlement system to the data warehouse using the generic addendum or Corporate addendum record. The data table would be resident in the data warehouse and would ‘translate’ UPC codes into the intelligence required for delivery of specific targeted offers (e.g. UPC 1234567891234=Acme DVD player model 4).

In optional decision block 314, it is determined whether data is to be gathered for additional transactions. If such is the case, steps of (i) facilitating obtaining the transaction data (e.g., 308, 310), and (ii) facilitating storage 312 can be repeated for a plurality of transactions, at a plurality of sales entities, to generate a cross-transaction, cross-entity, actual-product-purchased-based data warehouse profile of the holder, as shown at the “YES” branch of decision block 314. If not, as indicated at the “NO” branch, processing flow can continue with optional step 316, which can include facilitating performance of analysis on the attribute data (in, e.g., the data warehouse). The analysis can be performed to generate an offer. As used herein, “offer” should be broadly understood to include one or more of an incentive (which can, if desired, be product-specific), an electronic coupon, a rebate, and an award. The analysis can include one or more of identification of purchase trends and opportunities to influence future purchases, and identification of trigger behavior. Many criteria can be used to decide if more data is to be gathered. In some embodiments, data can be gathered on a continuous basis, whenever a transaction is conducted.

Step 318 includes facilitating generating a non-real-time offer to the holder, the offer being based, at least in part, on data mining performed on the data warehouse profile, the offer being generated by an operator of the payment card network (possibly based at least in part on offer content from a third party such as a merchant, issuer, manufacturer, or the like). If desired, the data mining can, be part of the analysis described above.

The non-real-time offer could be a printable coupon dispatched to the holder, or a statement credit for the holder, appearing on a statement for the payment card of the holder. In some embodiments, the statement credit is not tied to any given one of the transactions; in other embodiments, it could be. In one or more embodiments, when the data warehouse profile indicates that the holder is loyal to a given brand, the non-real-time offer comprises an inducement to reinforce loyalty to the given brand. Further, in one or more embodiments, when the data warehouse profile indicates that the holder is indifferent to a given brand, and the non-real-time offer comprises an inducement to develop loyalty to the given brand. The step 318 of facilitating generating the non-real-time offer can, in one or more embodiments, include identifying trigger behavior and generating a corresponding product-specific incentive, the non-real-time offer comprising the product-specific incentive.

Additional optional method steps 320, 322 can include, respectively, facilitating communication of a message describing the offer to the holder, and facilitating delivery of the offer to the holder in accordance with the offer delivery method selected by the holder in step 306. Delivery of the offer can encompass fulfillment of the offer. It is presently contemplated that fulfillment of the offer will occur at a time subsequent to a transaction, e.g., via a rebate to a holder's account, a coupon, a stored value card, and the like. As used herein, including the claims, a “non-real-time offer” is intended to encompass (i) an offer that is not presented during a transaction, and (ii) an offer that is provided during a transaction, e.g., at a point of sale, but not based on such (current) transaction. For example, an offer could be presented at a point of sale, during a transaction for which data is to be gathered and mined, but the offer would not be based on that particular transaction, as such data would only get to the warehouse during clearance. Conversely, “real-time rewards” are those that are a result of the particular transaction, where the offer/reward occurs at the point of service.

Steps 320 and 322 can thus include one or more of: facilitating generation of a message to an issuer of the card, the message comprising a specification of the offer (e.g., statement rebate, coupon, amount, delivery mode), the message being generated by the operator of the payment card network; facilitating fulfillment of the offer, the fulfillment being carried out by the operator of the payment card network; and delivering the offer to the holder. Any of these steps can be conducted in any order and all of the steps need not necessarily be performed.

In optional decision block 324, it is determined whether there are additional transactions for which offers are to be generated (offer generation need not necessarily be linked to any transaction or series of transactions—offers could periodically be generated based on criteria other than recent transactions, for example, lack of recent transactions, passage of time, or other criteria such as a manufacturer having an excess of product). If such is the case, as indicated by the “YES” branch, one or more of steps 316, 318, 320 and 322 can be repeated, thus facilitating generation of additional offers for the additional transactions. It should be noted that the use of two decision blocks 314, 324 is optional, and reflects one possible approach wherein a certain quantity of data is first gathered by looping through steps 308-312, and then offers are generated for transactions in the just-described loop from decision block 324. It should be understood, however, that other approaches could be employed. For example, as indicated by the dotted line from the “YES” branch of block 324 to the point prior to step 308, one could simply employ a single loop where obtaining data, storing data, analyzing data, and generating offers were performed sequentially, and another loop through the process was initiated when a new transaction occurred. If desired, some default logic could be provided for offer generation when there were no, or limited, data points with respect to a given holder. If decision block 324 yields a “NO,” processing flow can move to “CONTINUE” block 326 indicating the end of a pass through the process (but of course, processing can continue when additional triggering events occur, such as opting-in of additional holders, conducting of additional transactions, availability of additional data to support analysis, and the like.)

It should also be appreciated that any one or more of the steps can be repeated for a plurality of additional holders of additional cards usable in the payment card processing network.

There are many ways to enable the functionality required to execute product-specific targeted offers in accordance with one or more exemplary embodiments of the present invention. It should be noted that in general, the transactions processed in the scheme of FIG. 3 are with a number of different holders and different payment devices. Further, the offers can be from a number of different entities, such as payment device issuers, merchants, and manufacturers. As noted, the payment device employed could be a debit card, a credit card, a prepaid or offline balance card, an appropriately configured cellular telephone handset, or a device employing combinations of features; payment need not be the device's primary purpose, so long as it can interact with the other system components as required and desired. As noted above, the items in a given transaction can be products and/or services. In the case of services, appropriate identifying indicia (e.g., a bar code on a piece of paper or other transaction token) representative of the service could be scanned.

It should be noted that the data storage is not limited to the attribute data described. For example, the step of facilitating storage can include facilitating storage of additional data, which could include one or more of quantity data associated with the transaction, supplemental item description data (i.e., additional descriptive material beyond that available from the UPC code), and the payment data (which could include at least the price(s) of the item(s)). The attribute data and the additional data could be communicated to the data warehouse via the clearing and settlement system. The functionality described in this paragraph could be achieved, for example, by expanding existing addendum records to include UPC-level data. This solution could leverage the existing technology and data elements for passing line item detail through existing clearing and settlement systems. One potential advantage of this solution is that, as noted, additional, relevant information could be passed along with the item identifier (e.g. UPC code), for example, the price of the item, other item descriptors, quantity, etc.

The attribute data could include a promotion code tied to a given item and the step of facilitating obtaining the attribute data could be performed via a transaction authorization platform. Such platforms are per se well known to persons skilled in the electronic commerce art. This solution could take advantage of capabilities within existing authorization platforms. It would require merchants to recognize a promotion code tied to a specific item, and to separately & deliberately capture and communicate that promotion code at the POS. This solution could potentially require more training and process change at the point of sale than the other options.

In view of the foregoing discussion, it will be appreciated that a portable payment device employed with one or more exemplary embodiments of the present invention can include a body portion, a memory associated with the body portion, and at least one processor associated with the body portion and coupled to the memory. The memory can contain one or more applications. The processor can be operative to perform one or more of the method steps described herein (although it is presently believed that performance of method steps via processing capability in terminals 122, 124, 125, 126 and remote processing centers 140, 142, 144 is preferred).

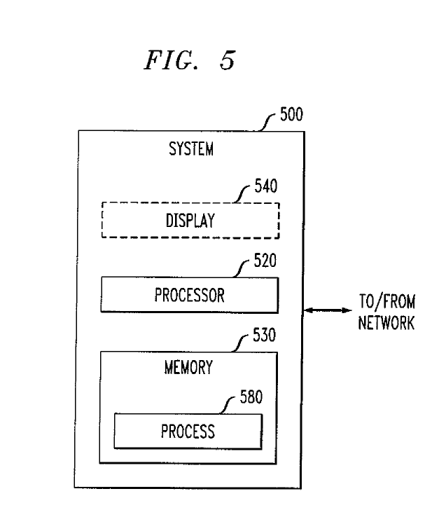

It will also be appreciated that a terminal apparatus for coordinating transaction data associated with a payment device of a holder can include a reader module, a memory, an item interface module (such as a bar code scanner and/or an RFID tag reader) and at least one processor coupled to the memory, the reader module, and the item interface module. The processor can be operative to perform one or more of the method steps described herein; as noted, in one possible preferred embodiment, in conjunction with processing capability in a remote processing center such as 140, 142, 144. For example, the processor in the terminal could facilitate obtaining the payment and attribute data and facilitate their storage in a remote database by formatting them for transmission over network 138. A network connection module (represented by the double-headed arrow labeled “TO/FROM NETWORK” in FIG. 5, to be discussed below) could be included in the terminal to allow communication with processing centers 140, 142, 144 via network 138 for storage and other purposes. Again, while it is believed preferable that techniques of the present invention are implemented in such a manner, it should be understood that method steps and actions described herein can be performed by a “smart” payment device, a terminal, a remote processing center, or a combination of the foregoing. Further, steps could be facilitated by the operator of the payment card network by appropriate data specification, operation of a processor and data warehouse configured to facilitate the steps, and the like.

Thus, in general terms, an exemplary embodiment of an apparatus for coordinating transaction data for targeted offer generation includes a memory and at least one processor coupled to the memory and operative to perform one or more of the method steps described herein. In another aspect, an apparatus for coordinating transaction data for targeted offer generation includes means for performing one or more method steps as described herein. The means can include hardware modules, software modules, or combinations thereof. Further, one or more method steps of the present invention can be implemented in the form of an article of manufacture comprising a machine readable medium that contains one or more programs which when executed implement described method step(s). Additional details are presented with respect to FIG. 5.

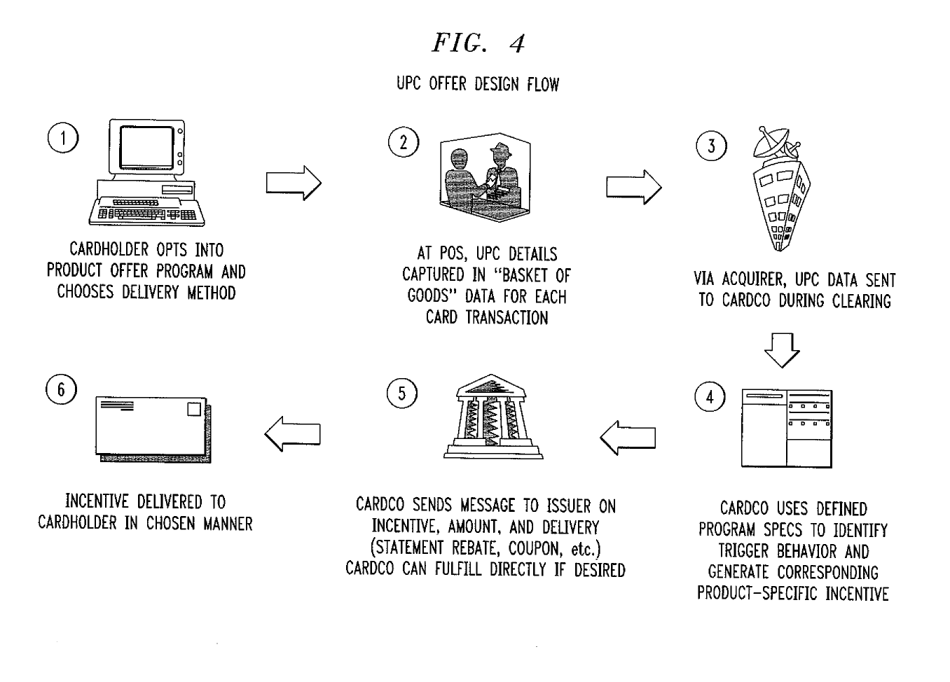

FIG. 4 shows one specific design flow for implementing customer offers based on UPC data. In the step labeled 1, a holder of a card or other payment device opts into the product offer program (or an issuer or other entity does this on behalf of the cardholder) and chooses a delivery method. In the step labeled 2, at the POS, UPC (or SKU or other) details are captured in “basket of goods” data for each card transaction. In the step labeled 3, via an acquirer, the UPC data is sent to an entity such as a credit card company “Cardco” (operator of a payment system) during clearing. In the step labeled 4, Cardco uses defined program specifications to identify trigger behavior and generate a corresponding product-specific incentive or incentives. In the step labeled 5, Cardco sends a message to the issuer on incentive, amount, and delivery (statement rebate, coupon, etc.). Cardco can fulfill directly if desired. In the step labeled 6, the incentive (offer) is delivered to the holder in the chosen manner.

Thus, one or more exemplary embodiments of the present invention may provide a system and process for capturing individual product data being purchased at the point of sale, and passing that information along with the financial, card transaction information to an electronic data warehouse. This would be relevant, and could be made available, to credit, debit, or prepaid cardholders. Based on criteria defined by the sponsors of a product-specific offer, such as card issuers, merchants, or manufacturers, the system would analyze the purchase data to identify trends and opportunities to influence future purchasing, and could trigger a product specific incentive for cardholders who have opted to participate in the reward program. Existing networks and systems that perform transaction authorization and clearing transactions could be augmented to enable the necessary data warehouse and scoring platforms to create a system and method available to multiple issuers, merchants and manufacturers. Cardholders who opt in would benefit from the promotional offerings that are more relevant and more likely to influence their future purchasing behavior. This would also be a substantial improvement of the current paper coupon process as merchants and manufacturers would be able to target specific consumers or behaviors to drive the desired purchases in significantly more effective and cost-efficient manner. The incentive or offer could happen after the sale as a rebate to the cardholder's account or in the form of a coupon or stored value card. Techniques of one or more exemplary embodiments of the present invention can provide an open-loop approach, workable with multiple merchants, and which can be adapted to reward behavior in addition to influencing future buying decisions.

The invention can employ hardware and/or software aspects. Software includes but is not limited to firmware, resident software, microcode, etc. Software might be employed, for example, in connection with a terminal 122, 124, 125, 126, or a processing center 140, 142, 144 with data warehouse 154. Firmware might be employed, for example, in connection with payment devices such as cards 102, 112. FIG. 5 is a block diagram of a system 500 that can implement part or all of one or more aspects or processes of the present invention. As shown in FIG. 5, memory 530 configures the processor 520 (which could correspond, e.g., to processor portions 106, 116, 130 or processors of remote hosts in centers 140, 142, 144) to implement one or more aspects of the methods, steps, and functions disclosed herein (collectively, shown as process 580 in FIG. 5). The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices.

System and Article of Manufacture Details

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on elements 102, 112, 122, 124, 125, 126, 140, 142, 144 or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention, such as, for example, the aforementioned terminals 122, 124, 125, 126, processing centers 140, 142, 144 with data warehouse 154, or payment devices such as cards 102, 112 can make use of computer technology with appropriate instructions to implement method steps described herein. By way of further example, a terminal apparatus 122, 124, 125, 126 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe).

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer-implemented method for coordinating transaction data for targeted offer generation, said transaction data being associated with a payment card of a holder, said payment card being usable in a payment card processing network, said method comprising the steps of:
facilitating opt-in to a cardholder offer generation scheme;
facilitating obtaining transaction data associated with a transaction conducted with said card, said transaction data being obtained via said payment card processing network, said transaction data comprising:
attribute data indicative of an attribute of at least one item purchased in said transaction; and
an account number of said card, said account number identifying said holder;
facilitating storage of at least said attribute data in a data warehouse, in association with indicia of said holder, in a form for subsequent data mining thereon;
repeating said steps of (i) facilitating obtaining said transaction data, and (ii) facilitating storage, for a plurality of transactions at a plurality of sales entities, to generate a cross-transaction, cross-entity, actual-product-purchased-based data warehouse profile of said holder; and
facilitating generating a non-real-time offer to said holder, said offer being based, at least in part, on data mining performed on said data warehouse profile, said offer being generated by an operator of said payment card network.

2. The method of claim 1, wherein said attribute data comprises a universal product code (UPC).

3. The method of claim 1, wherein said non-real-time offer comprises a printable coupon dispatched to said holder.

4. The method of claim 1, wherein said non-real-time offer comprises a statement credit for said holder, said statement credit appearing on a statement of said holder, said statement being a statement for said payment card.

5. The method of claim 4, wherein said statement credit is not tied to any given one of said transactions.

6. The method of claim 4, wherein said statement credit is tied to a given one of said transactions.

7. The method of claim 1, wherein said data warehouse profile indicates that the holder is loyal to a given brand, and said non-real-time offer comprises an inducement to reinforce loyalty to said given brand.

8. The method of claim 1, wherein said data warehouse profile indicates that the holder is indifferent to a given brand, and said non-real-time offer comprises an inducement to develop loyalty to said given brand.

9. The method of claim 1, wherein said attribute data is obtained during a clearing operation.

10. The method of claim 9, wherein said attribute data is obtained as a record in a file associated with said clearing operation.

11. The method of claim 1, wherein said step of facilitating generating said non-real-time offer comprises identifying trigger behavior and generating a corresponding product-specific incentive, said non-real-time offer comprising said product-specific incentive.

12. The method of claim 1, further comprising the additional step of facilitating generation of a message to an issuer of said card, said message comprising a specification of said offer, said message being generated by said operator of said payment card network.

13. The method of claim 1, further comprising the additional step of facilitating fulfillment of said offer, said fulfillment being carried out by said operator of said payment card network.

14. The method of claim 1, further comprising the additional step of delivering said offer to said holder.

15. The method of claim 1, wherein said opt-in further comprises selection of a preferred offer-delivery method.

16. The method of claim 1, further comprising the additional step of repeating said steps of:
facilitating opt-in,
facilitating obtaining transaction data,
facilitating storage,
repeating facilitating obtaining transaction data and facilitating storage, and
facilitating generating said offer
for a plurality of additional holders of additional cards usable in said payment card processing network.

17. The method of claim 1, wherein said item is one of a product and a service.

18. The method of claim 1, wherein said attribute data is indicative of multiple items purchased in said transaction.

19. The method of claim 18, wherein said attribute data comprises numerical indicia, further comprising the additional step of translating said numerical indicia into offer intelligence data via a data table associated with said data warehouse.

20. The method of claim 19, wherein said numerical indicia comprise universal product codes (UPCs).

21. The method of claim 1, wherein said step of facilitating storage further comprises facilitating storage of additional data, said additional data comprising at least one of:
quantity data associated with said transaction;
supplemental item description data; and
a price associated with said item.

22. The method of claim 1, wherein said attribute data comprises a promotion code tied to said at least one item.

23. The method of claim 1, wherein said opt-in is by said holder of said card.

24. The method of claim 1, wherein said opt-in is by an issuer of said card on behalf of said holder of said card.

25. The method of claim 1, wherein said operator of said payment card network generates said offer, at least in part, via offer content from a third party.

26. A computer program product comprising a computer useable medium including computer usable program code for coordinating transaction data for targeted offer generation, said transaction data being associated with a payment card of a holder, said payment card being usable in a payment card processing network, said computer program product including:
computer usable program code for facilitating opt-in to a cardholder offer generation scheme;
computer usable program code for facilitating obtaining transaction data associated with a transaction conducted with said card, said transaction data being obtained via said payment card processing network, said transaction data comprising:
attribute data indicative of an attribute of at least one item purchased in said transaction; and
an account number of said card, said account number identifying said holder;
computer usable program code for facilitating storage of at least said attribute data in a data warehouse, in association with indicia of said holder, in a form for subsequent data mining thereon;
computer usable program code for repeating said steps of (i) facilitating obtaining said transaction data, and (ii) facilitating storage, for a plurality of transactions at a plurality of sales entities, to generate a cross-transaction, cross-entity, actual-product-purchased-based data warehouse profile of said holder; and
computer usable program code for facilitating generating a non-real-time offer to said holder, said offer being based, at least in part, on data mining performed on said data warehouse profile, said offer being generated by an operator of said payment card network.

27. An apparatus for coordinating transaction data for targeted offer generation, said transaction data being associated with a payment card of a holder, said payment card being usable in a payment card processing network, said apparatus comprising:
a memory; and
at least one processor coupled to said memory, said processor being operative to:
facilitate opt-in to a cardholder offer generation scheme;
facilitate obtaining transaction data associated with a transaction conducted with said card, said transaction data being obtained via said payment card processing network, said transaction data comprising:
attribute data indicative of an attribute of at least one item purchased in said transaction; and
an account number of said card, said account number identifying said holder;
facilitate storage of at least said attribute data in a data warehouse, in association with indicia of said holder, in a form for subsequent data mining thereon;
repeat said steps of (i) facilitating obtaining said transaction data, and (ii) facilitating storage, for a plurality of transactions at a plurality of sales entities, to generate a cross-transaction, cross-entity, actual-product-purchased-based data warehouse profile of said holder; and
facilitate generating a non-real-time offer to said holder, said offer being based, at least in part, on data mining performed on said data warehouse profile, said offer being generated by an operator of said payment card network.

28. An apparatus for coordinating transaction data for targeted offer generation, said transaction data being associated with a payment card of a holder, said payment card being usable in a payment card processing network, said apparatus comprising:
means for facilitating opt-in to a cardholder offer generation scheme;
means for facilitating obtaining transaction data associated with a transaction conducted with said card, said transaction data being obtained via said payment card processing network, said transaction data comprising:
attribute data indicative of an attribute of at least one item purchased in said transaction; and
an account number of said card, said account number identifying said holder;
means for facilitating storage of at least said attribute data in a data warehouse, in association with indicia of said holder, in a form for subsequent data mining thereon;
means for repeating said steps of (i) facilitating obtaining said transaction data, and (ii) facilitating storage, for a plurality of transactions at a plurality of sales entities, to generate a cross-transaction, cross-entity, actual-product-purchased-based data warehouse profile of said holder; and
means for facilitating generating a non-real-time offer to said holder, said offer being based, at least in part, on data mining performed on said data warehouse profile, said offer being generated by an operator of said payment card network.
